(19) United States
(12) Patent Application Publication
(10) Pub. No.: US 2011/0087683 A1
(43) Pub. Date: Apr. 14, 2011

(54) IMPLEMENTATION OF A SOFTWARE FRAMEWORK/DATA ARK SYSTEM

(76) Inventors: Anthony J. Paparella, Akron, OH (US); James C. Charles, Strongsville, OH (US); Philip M. Hayes, Hinckley, OH (US); Robert B. Hayes, North Ridgeville, OH (US)

(21) Appl. No.: 12/899,582

(22) Filed: Oct. 7, 2010

Related U.S. Application Data
(60) Provisional application No. 61/249,647, filed on Oct. 8, 2009.

(51) Int. Cl. G06F 17/30

(52) U.S. Cl. 707/756; 707/809; 707/E17.005

(57) ABSTRACT

A software framework architecture that allows for the migration of data from legacy systems to a DataArk database. The DataArk database acts as a central storage component for disparate data sets. Data is extracted from the legacy systems, transformed into a text format and then mapped into the DataArk database. Users are then able to access the DataArk database as they would access the legacy systems, looking up individual patient accounting detail, clinical detail, employee records, etc. Users are also able to edit and manage the data in the DataArk database. The legacy systems are then decommissioned. Further, the DataArk database is configured for use by establishing user access, permitted functions and permitted views. A system administrator establishes user profiles that specify which functions and screens a user may access. Once users are logged-in the system, users may perform searches on the data to which they have been given access.

### CROSS-REFERENCE

This application claims priority from Provisional Patent Application Ser. No. 61/249,647 filed Oct. 8, 2009.

### BACKGROUND

Healthcare providers and other organizations often maintain old software applications in order to manage and access vital financial data, patient care data, operations data and other specific data elements. The legacy systems require high support costs, thus keeping the old system for management of accounts receivable, revenue cycle managerial archiving purposes and compliance with data retention regulations is cost prohibitive. Further, the legacy data must often be maintained for several years to defend against audits and take-backs. Thus, these legacy systems become a burden to the organizations but cannot be eliminated without a solution for managing, storing and accessing the data that the legacy systems contain.

However, implementing new systems is a major undertaking requiring many hours of planning and configuring. Full data conversions into a new system are riddled with risk, often discouraging vendors, consultants and hospital staff from converting data into the new production system. Saving data as images is an incomplete option that does not allow for complete access and manipulation of the old data. And, balance forward methodologies are incomplete, exposing the organizations to risks of non-compliance and revenue loss from unpaid bills. Accordingly, hospitals, healthcare systems and other organizations need to decommission old applications, reduce legacy software application costs, retain the required functions to manage the old data (a “bridge” until the old data from the legacy system no longer requires manipulation) and retain real time, user access to vital healthcare data and other data from the legacy systems.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

A software framework architecture is disclosed that allows for the migration of data from legacy systems to a DataArk database for storage and processing. The DataArk database acts as a central storage component for disparate data sets. Data is extracted from the legacy systems and transformed into a text format. The extracted data is then mapped into the DataArk database. Users are then able to access the DataArk database as they would access the legacy systems, looking up individual patient accounting detail, clinical detail, employee records, updating records, posting payments, etc. The legacy systems are then decommissioned. Accordingly, the DataArk database acts as an archive that can be used for the combination of archiving individual data elements and images, updating old records(using functions such as posting payments, billing accounts and, interfacing with other systems), allowing access to records, and retaining data in one central repository.

Furthermore, the DataArk database is configured for use by establishing user access, permitted functions and permitted views. A system administrator establishes user profiles that specify which functions and screens users may access. The system administrator also establishes user accounts in the system and applies one or more user profiles to each user. Each user is then provided with an initial log-in and password. Users may be restricted to the data that they are permitted to use. Once the users are logged-in the system, users may perform searches on the data to which they have been given access.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented software framework system in accordance with the disclosed architecture.

FIG. 2 illustrates an embodiment of a software framework system wherein a data extraction process is used to extract data from a legacy system and transmit the data to a DataArk database component.

FIG. 3 illustrates an alternative embodiment of a software framework system wherein a user logs-on via a graphical user interface.

FIG. 4 illustrates another alternative embodiment of a software framework system wherein a user is allowed to manipulate the data within the DataArk database component.

FIG. 5 illustrates a computer-implemented software framework method.

FIG. 6 illustrates further aspects in the software framework method of FIG. 5.

FIG. 7 illustrates further aspects in the software framework method of FIG. 6.

FIG. 8 illustrates a block diagram of a computing system operable to execute the software framework in accordance with the disclosed architecture.

FIG. 9 illustrates an exemplary computing environment operable to provide support for the software framework.

### DETAILED DESCRIPTION

The disclosed architecture provides a software framework wherein data from legacy systems is migrated to a DataArk database for storage and processing. The DataArk database acts as a central storage component for disparate data sets. For example, clinical, financial, Enterprise Resource Planning, supply chain and other data sets may all be accessed by users within the same DataArk framework. Data is extracted from the legacy systems, transformed into a text format and then mapped into the DataArk database. Tables and fields may be added to the DataArk database to accommodate data elements that are not already in the standard DataArk data sets. The DataArk database is then configured for use by establishing user access, standard master tables, permitted functions and permitted views. Once users are logged-in to the system, users may perform searches on the data to which they have been given access. Users may also modify the data in the DataArk database. Thus, users are able to access the DataArk database as they would access the legacy systems, looking up individual patient accounting detail, clinical detail, employee records, updating records, posting payments, etc. The legacy systems are then decommissioned. Accordingly, the DataArk database acts as an archive that can be used for the combination of archiving, updating old records (by using functions such as, posting payments, billing accounts and adding notes), allowing access to individual records, reporting, querying data and retaining data in one central repository.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

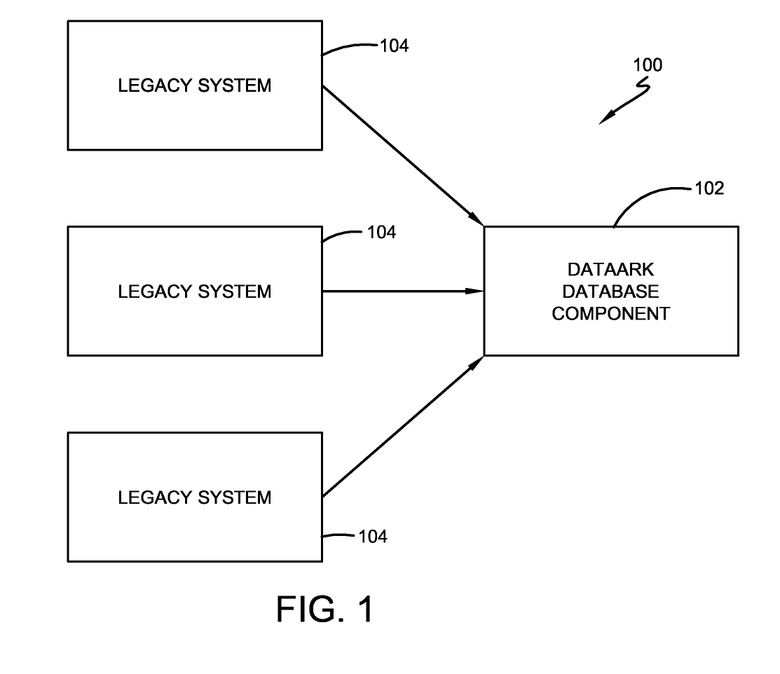

FIG. 1 illustrates a computer-implemented software framework system 100 in accordance with the disclosed architecture. The software framework system 100 includes a DataArk database component 102 that is configured with a pre-established data schema. The DataArk database component 102 acts as a central storage component for disparate data sets. For example, data from legacy systems 104 can be migrated to the DataArk database component 102 for storage and processing. The DataArk database component 102 accommodates multiple types of data sets, such as human resources, patient management, patient accounting, radiology, payroll, Enterprise Resource Planning, charts, laboratory, registration, medical records, custom data sets, clinical, etc. in one database. Once the data from legacy systems 104 is migrated to the DataArk database component 102, the legacy systems 104 are then decommissioned.

The DataArk database component 102 also serves as the system of record for the daily flow of notes and transactions generated between a user and other vendors. Furthermore, the DataArk database component 102 allows users to manage, process, add, edit and delete this stored data. Tables and fields may be added to the DataArk database to accommodate data elements that are not already in the standard DataArk data sets. For example, the DataArk database component 102 comprises standard master tables, such as payment code master tables, wherein migrated data populates these standard master tables. Accordingly, referential integrity of the data is maintained, allowing the relationships between the data records to still exist. Thus, the DataArk database component 102 acts as an archive that can be used for the combination of archiving, updating old records, allowing access to records, and retaining data in one central repository.

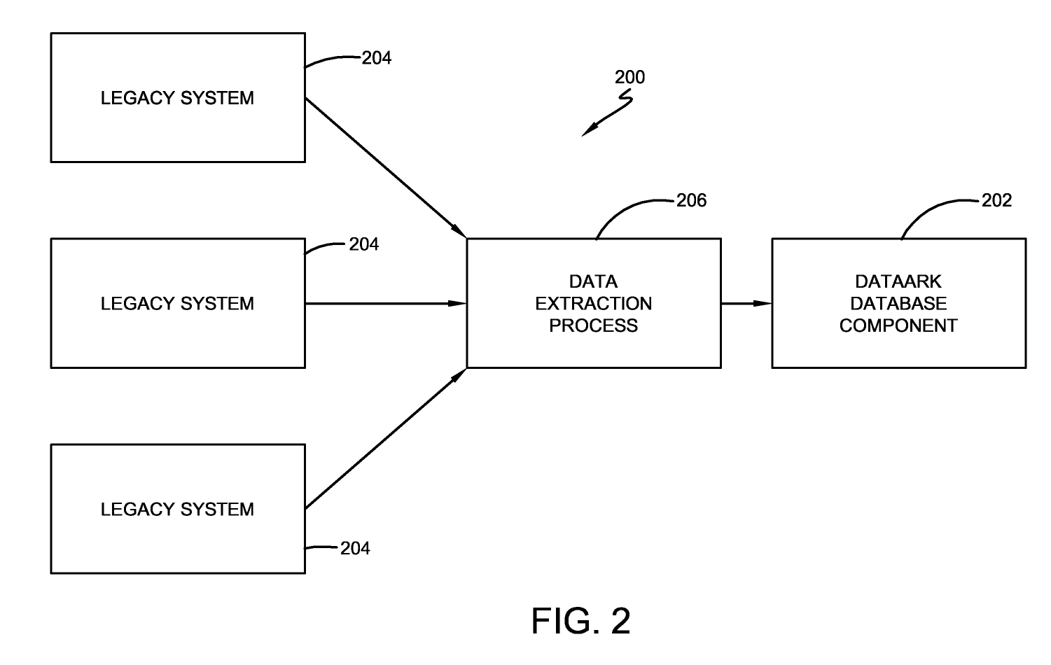

FIG. 2 illustrates an embodiment of a software framework system 200 for maintaining legacy data. The software framework system 200 includes a data extraction process 206 that migrates legacy data from the legacy systems 204 to the DataArk database component 202. Typically, data extraction is performed by consultants and/or the client using the data extraction process 206. The data extraction process 206 extracts data from the legacy systems 204 and transforms the extracted data into a text format. The extracted data is then mapped into the DataArk database component 202. Thus, the extracted data is migrated, not converted, from the legacy system 204 into the DataArk database component 202. Since the extracted data is migrated and not converted, the extracted data retains it's original intent allowing the relationships between the data records to remain. Users are then able to access the DataArk database component 202 as they would access the legacy systems 204, looking up individual patient accounting detail, clinical detail, employee records, etc. and modifying data. Accordingly, the data mapped to the DataArk database component 202 is not being restored or brought back from another system or on a secondary device, but is available to users as it was with the legacy system, and can be manipulated, managed, edited, etc. The legacy systems 204 are then decommissioned. The DataArk database component 202 also maintains extensive logs and audit trails for the manipulated, managed and edited data, so that any changes are recorded and saved for historical purposes. Thus, the software framework system 200 comprising the DataArk database component 202, acts as a central repository, archive and comprises an editing functionality for extracted data from the legacy systems 204.

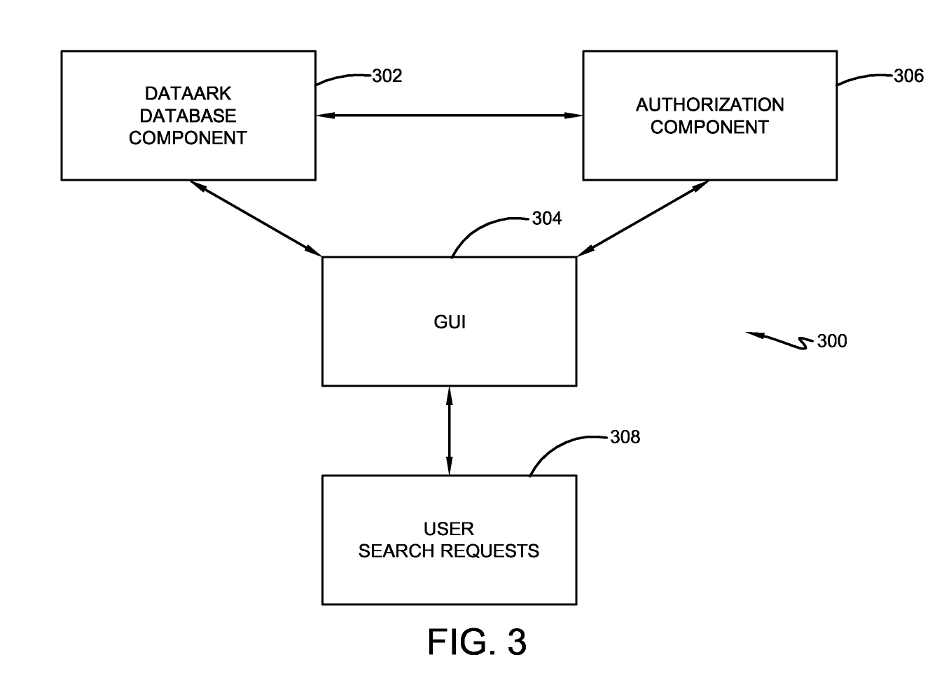

FIG. 3 illustrates an alternative embodiment of a software framework system 300 wherein a DataArk database component 302 is configured for use by establishing user access, permitted functions and permitted views. Specifically, once the extracted data has been mapped into the DataArk database component 302, users, regardless of which data set they wish to view, may log-in into a graphical user interface (GUI) 304. An authorization component 306 then establishes user access, permitted functions and permitted views. Specifically, a system administrator establishes user profiles that specify which functions and screens users may access. The system administrator also establishes user accounts in the system and applies one or more user profiles to each user, thus allowing each user to access only data and functions intended for access by each user. The authorization component 306 then provides a user with an initial log-in and password, which password will expire at a pre-determined time period at which time the user is required to establish a new password. Additionally, user log-ins and passwords may be terminated by the system administrator at any time.

The authorization component 306 then verifies a user's password and sign-in credentials, and based on this information, the authorization component 306 accesses the user profiles and allows the logged-in user access to only data and functions intended for access by the user and sets any restrictions as specified by the user profiles. Users can be restricted to the data sets that they are permitted to use. Once the users are logged-in the system 300, users may generate user search requests 308 on the data to which they have been given access. For example, users permitted to view hospital billing information can perform a search for a patient or an account, users permitted to view patient accounting information can perform a search for a patient, an account or a guarantor, and users permitted to view human resource information can perform a search for an employee. Once found, the complete data set for the desired record will be viewable through one or more screens. Users can run both searches and queries on the data, and can search for record-level reports, such as a search for a specific patient's account, or for aggregate reports, such as the total amount billed on multiple accounts, etc.

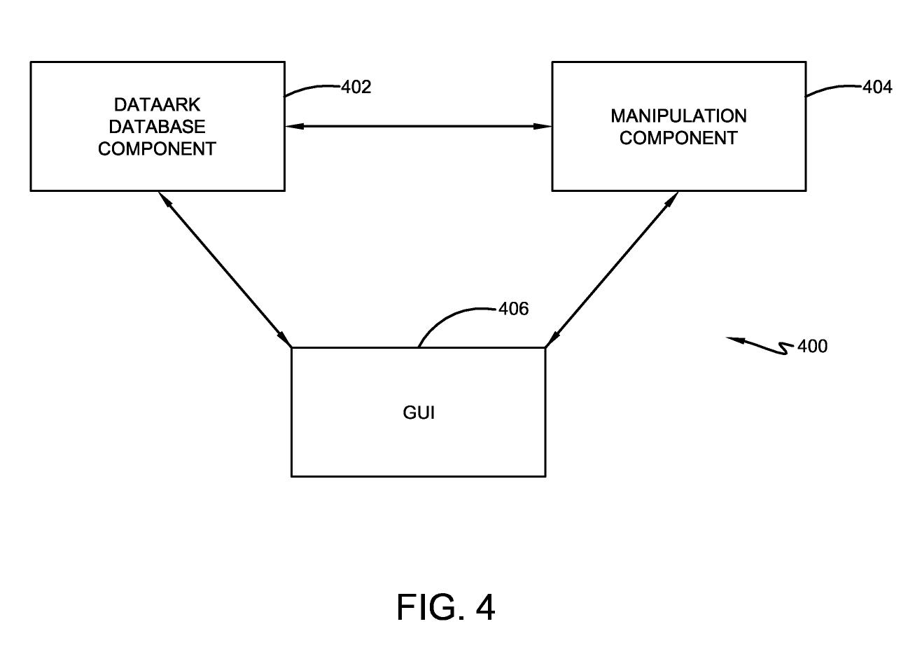

FIG. 4 illustrates an alternative embodiment of a software framework system 400 further comprising a manipulation component 404. The manipulation component 404 allows users to manipulate the data within the DataArk database component 402. Specifically, the manipulation component 404 allows users to add, edit or delete data. For example, for billing data sets users may seek to apply payments, adjustments and refunds to accounts. For other datasets, demographic data for individuals may be edited. Additionally, aggregate reports can be produced for the archived data and new information can be added by users. Accordingly, the software framework system 400 allows real-time, user access to data via the graphical user interface (GUI) 406. Thus, the software framework system 400 comprising the DataArk database component 402, the manipulation component 404 and the GUI 406, acts as a central repository, archive and comprises an editing functionality for extracted data from legacy systems. The DataArk database component 402 also maintains extensive logs and audit trails for the manipulated, added, edited and/or deleted data, so that any changes are recorded and saved for historical purposes.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

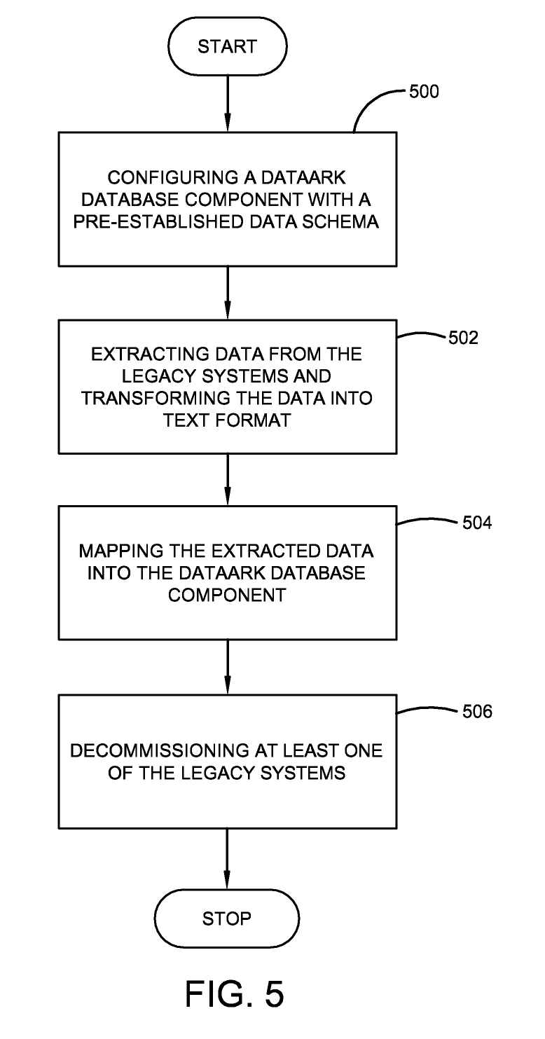

FIG. 5 illustrates a method of making data from legacy systems available to users. At 500, a DataArk database component is configured with a pre-established data schema. The DataArk database component acts as a central storage component for disparate data sets. For example, data from legacy systems is transferred to the DataArk database component for storage and processing. The DataArk database component accommodates multiple types of data sets, such as human resources, patient accounting, clinical, etc. in one database. The DataArk database component allows users to manage, process, add, edit and delete this stored data.

At 502, data is extracted from the legacy systems and transformed into a text format. At 504, the extracted data is mapped into the DataArk database component. Thus, the extracted data is migrated, not converted, from the legacy system into the DataArk database component. Users are then able to access the data mapped to the DataArk database component as they would access the legacy systems, looking up individual patient accounting detail, clinical detail, employee records, etc. And, at 506, the legacy systems are then decommissioned.

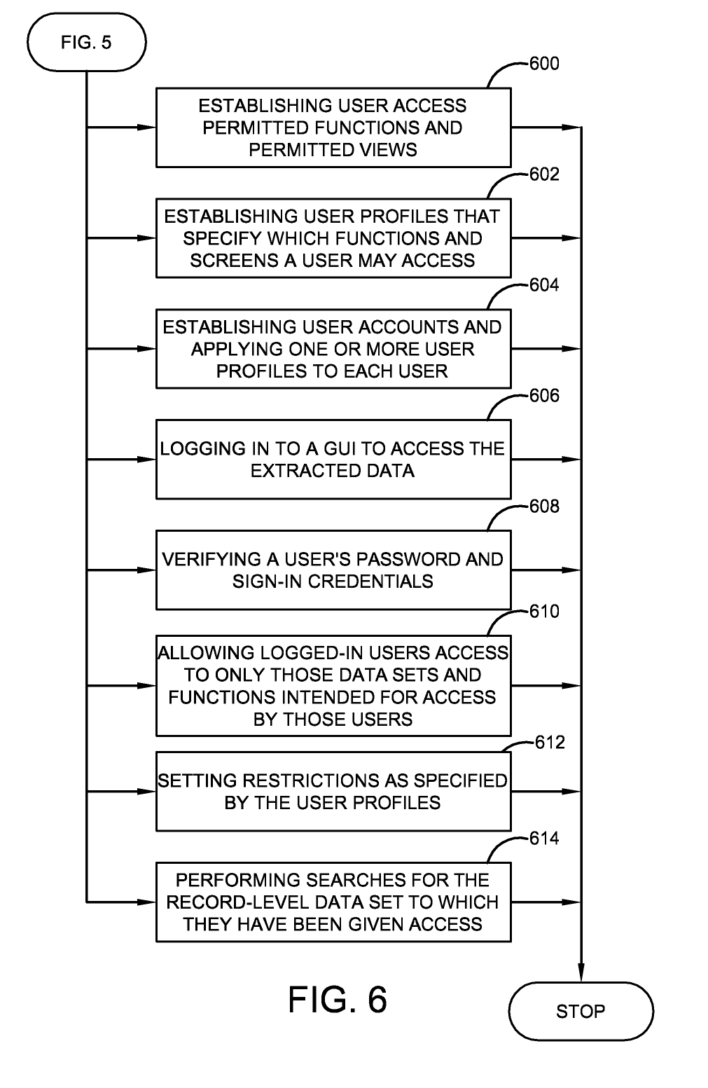

FIG. 6 illustrates further aspects in the software framework method of FIG. 5. At 600, user access, permitted functions and permitted views are established. At 602, user profiles that specify which functions and screens a user may access are established. At 604, user accounts in the system are established and one or more user profiles are applied to each user, thus allowing each user to access only data and functions intended for access by each user. At 606, users access the extracted data by logging-in to a graphical user interface (GUI). Specifically, once the extracted data has been mapped into the DataArk database component, users, regardless of which data set they wish to view, may log-in into a GUI. A user is provided with an initial log-in and password, which password will expire at a pre-determined time period at which time the user is required to establish a new password. Additionally, user log-ins and passwords may be terminated by a system administrator at any time.

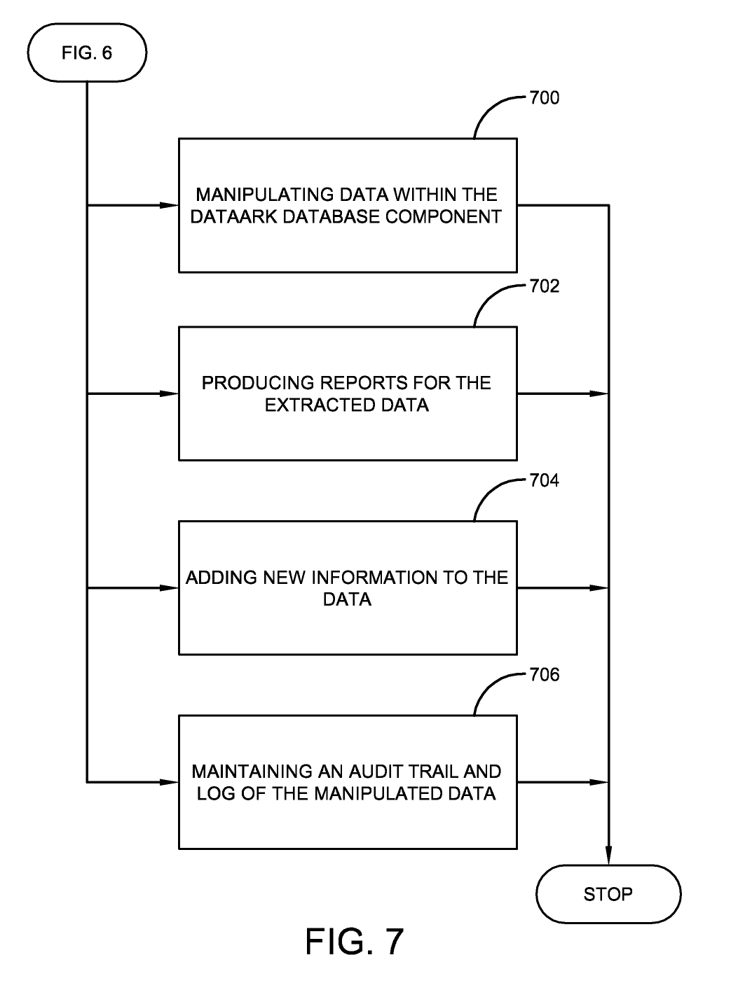

At 608, a user's password and sign-in credentials are verified, and based on this information, user profiles are accessed. At 610, logged-in users are allowed access to only data and functions intended for access by the user. At 612, restrictions as specified by the user profiles are set for the logged-in users. Users are then restricted to the data sets that they are permitted to use. At 614, users may perform searches on the data to which they have been given access. For example, users permitted to view hospital billing information can perform a search for a patient or an account. Once found, the complete data set for the desired record will be viewable through one or more screens. FIG. 7 illustrates further aspects in the software framework method of FIG. 6. At 700, an user is allowed to manipulate the data within the DataArk database component. Specifically, an user is allowed to add, edit or delete data. For example, for billing data sets the users seek to apply payments, adjustments and refunds to accounts. For other datasets, demographic data for individuals may be edited. At 702, reports are produced for the archived data by the users. At 704, new information is added to the data by the users. And, at 706, an audit trail and log of the manipulated data is maintained. The DataArk database component maintains extensive logs and audit trails for the manipulated, added, edited and/or deleted data, so that any changes are recorded and saved for historical purposes.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical, solid state, and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

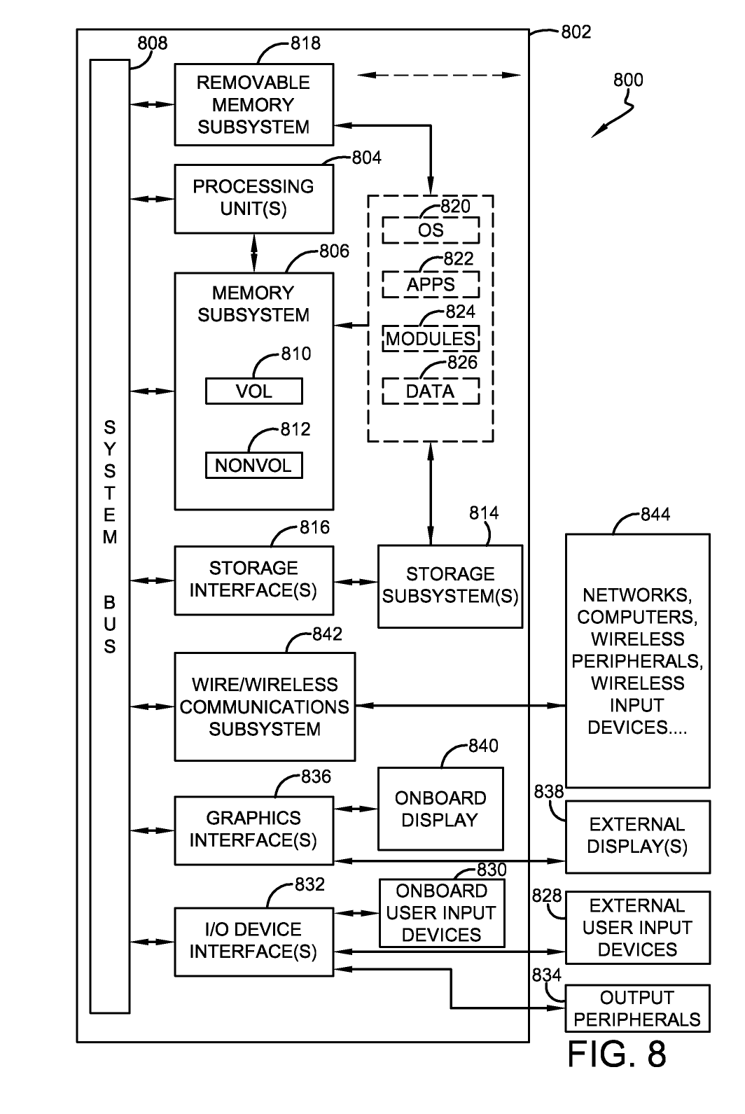

Referring now to FIG. 8, there is illustrated a block diagram of a computing system 800 operable to execute the software framework in accordance with the disclosed architecture. In order to provide additional context for various aspects thereof, FIG. 8 and the following discussion are intended to provide a brief, general description of the suitable computing system 800 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 800 for implementing various aspects includes the computer 802 having processing unit(s) 804, a system memory 806, and a system bus 808. The processing unit(s) 804 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 806 can include volatile (VOL) memory 810 (e.g., random access memory (RAM)) and non-volatile memory (NON-VOL) 812 (e.g., ROM, EPROM, EEPROM, etc.). A basic input/output system (BIOS) can be stored in the non-volatile memory 812, and includes the basic routines that facilitate the communication of data and signals between components within the computer 802, such as during startup. The volatile memory 810 can also include a high-speed RAM such as static RAM for caching data.

The system bus 808 provides an interface for system components including, but not limited to, the memory subsystem 806 to the processing unit(s) 804. The system bus 808 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 802 further includes storage subsystem(s) 814 and storage interface(s) 816 for interfacing the storage subsystem(s) 814 to the system bus 808 and other desired computer components. The storage subsystem(s) 814 can include one or more of a hard disk drive (HDD), a magnetic floppy disk drive (FDD), and/or optical disk storage drive (e.g., a CD-ROM drive DVD drive), for example. The storage interface(s) 816 can include interface technologies such as EIDE, ATA, SATA, and IEEE 1384, for example.

One or more programs and data can be stored in the memory subsystem 806, a removable memory subsystem 818 (e.g., flash drive form factor technology), and/or the storage subsystem(s) 814 (e.g., optical, magnetic, solid state), including an operating system 820, one or more application programs 822, other program modules 824, and program data 826.

The aforementioned application programs 822, program modules 824, and program data 826 can include the computer-implemented system 100 of FIG. 1, to include the DataArk database component 102, the entities and components of system 200 of FIG. 2, including the data extraction component 206, the data transformation component 208, and the mapping component 210, and, the entities and components and arrangement of system 300 of FIG. 3 and system 400 of FIG. 4. The aforementioned application programs 822, program modules 824, and program data 826 can also include the methods represented by flow charts of FIGS. 5-7, for example.

Generally, programs include routines, methods, data structures, other software components, etc., that perform particular tasks or implement particular abstract data types. All or portions of the operating system 820, applications 822, modules 824, and/or data 826 can also be cached in memory such as the volatile memory 810, for example. It is to be appreciated that the disclosed architecture can be implemented with various commercially available operating systems or combinations of operating systems (e.g., as virtual machines).

The storage subsystem(s) 814 and memory subsystems (806 and 818) serve as computer readable media for volatile and non-volatile storage of data, data structures, computer-executable instructions, and so forth. Computer readable media can be any available media that can be accessed by the computer 802 and includes volatile and non-volatile media, removable and non-removable media. For the computer 802, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 802, programs, and data using external user input devices 828 such as a keyboard and a mouse. Other external user input devices 828 can include a microphone, an IR (infrared) remote control, a joystick, a game pad, camera recognition systems, a stylus pen, touch screen, gesture systems (e.g., eye movement, head movement, etc.), and/or the like. The user can interact with the computer 802, programs, and data using onboard user input devices 830 such a touchpad, microphone, keyboard, etc., where the computer 802 is a portable computer, for example. These and other input devices are connected to the processing unit(s) 804 through input/output (I/O) device interface(s) 832 via the system bus 808, but can be connected by other interfaces such as a parallel port, IEEE 1384 serial port, a game port, a USB port, an IR interface, etc. The I/O device interface(s) 832 also facilitate the use of output peripherals 834 such as printers, audio devices, camera devices, and so on, such as a sound card and/or onboard audio processing capability.

One or more graphics interface(s) 836 (also commonly referred to as a graphics processing unit (GPU)) provide graphics and video signals between the computer 802 and external display(s) 838 (e.g., LCD, plasma) and/or onboard displays 840 (e.g., for portable computer). The graphics interface(s) 836 can also be manufactured as part of the computer system board.

The computer 802 can operate in a networked environment (e.g., IP) using logical connections via a wired/wireless communications subsystem 842 to one or more networks and/or other computers. The other computers can include workstations, servers, routers, personal computers, microprocessor-based entertainment appliance, a peer device or other common network node, and typically include many or all of the elements described relative to the computer 802. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet. Further, the software framework system can operate over the Internet in an Application Service Provider (ASP) environment, wherein the system is hosted at a data center and a user logs-in via a secure connection over the Internet.

When used in a networking environment the computer 802 connects to the network via a wired/wireless communication subsystem 842 (e.g., a network interface adapter, onboard transceiver subsystem, etc.) to communicate with wired/wireless networks, wired/wireless printers, wired/wireless input devices 844, and so on. The computer 802 can include a modem or has other means for establishing communications over the network. In a networked environment, programs and data relative to the computer 802 can be stored in the remote memory/storage device, as is associated with a distributed system. It will be appreciated that the network connections shown are exemplary and other means of establishing a communications link between the computers can be used.

The computer 802 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

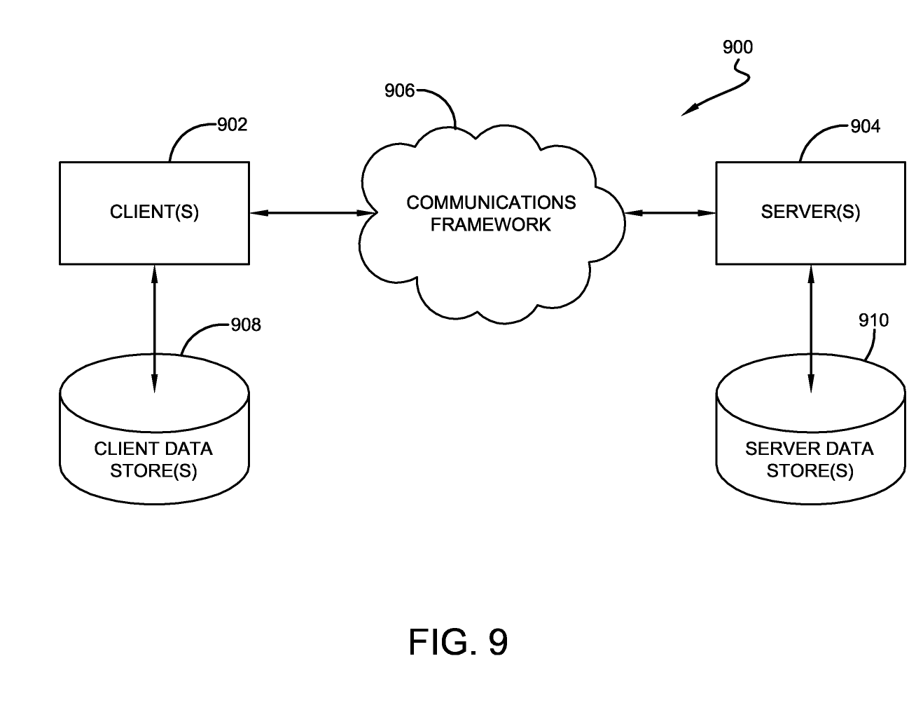

Referring now to FIG. 9, there is illustrated a schematic block diagram of a computing environment 900 operable to provide support for the software framework. The environment 900 includes one or more client(s) 902. The client(s) 902 can be hardware and/or software (e.g., threads, processes, computing devices). The client(s) 902 can house cookie(s) and/or associated contextual information, for example.

The environment 900 also includes one or more server(s) 904. The server(s) 904 can also be hardware and/or software (e.g., threads, processes, computing devices). The servers 904 can house threads to perform transformations by employing the architecture, for example. One possible communication between a client 902 and a server 904 can be in the form of a data packet adapted to be transmitted between two or more computer processes. The data packet may include a cookie and/or associated contextual information, for example. The environment 900 includes a communication framework 906 (e.g., a global communication network such as the Internet) that can be employed to facilitate communications between the client(s) 902 and the server(s) 904.

Communications can be facilitated via a wire (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented software framework system for maintaining legacy data comprising:
data from at least one legacy system; and
a database component that acts as a central storage component for disparate data sets; wherein the data from the at least one legacy system is migrated to the database component.

2. The software framework system of claim 1, wherein a data extraction process is used to extract the data from the at least one legacy system and map the data into the database component.

3. The software framework system of claim 2, wherein the data extracted from the at least one legacy system is transformed into a text format before being mapped into the database component.

4. The software framework system of claim 1, further comprising a graphical user interface that users log into for access to data in the database component.

5. The software framework system of claim 4, further comprising an authorization component that establishes user access, permitted functions and permitted views of the data in the database component.

6. The software framework system of claim 5, further comprising a system administrator that establishes user profiles that specify which functions and screens users may access.

7. The software framework system of claim 6, wherein the system administrator establishes user accounts in the software framework system and applies at least one profile to each user, allowing each user to access only data sets and functions intended for access by each user.

8. The software framework system of claim 7, wherein the authorization component provides each user with an initial log-in and password, and wherein the password will expire at a pre-determined time period.

9. The software framework system of claim 8, wherein user log-ins and passwords may be terminated by the system administrator at any time.

10. The software framework system of claim 9, wherein users generate user search requests for the data to which the users have been given access.

11. The software framework system of claim 10, further comprising a manipulation component that allows users to manipulate the data within the database component.

12. The software framework system of claim 11, wherein the manipulation component allows users to add, edit or delete data.

13. A computer-implemented method of making data from at least one legacy system available to users, using a processor coupled to a memory, comprising:
configuring a database component with a pre-established data schema;
extracting data from at least one legacy system;
transforming the data into text format;
mapping the extracted data into the database component; and
decommissioning the at least one legacy system.

14. The method of claim 13, further comprising:
establishing user access, permitted functions and permitted views of the data in the database component;
establishing user profiles that specify which functions and screens users may access;
establishing user accounts and applying one or more user profiles to each user; and
setting restrictions as specified by the user profiles.

15. The method of claim 13, further comprising:
logging-in to a graphical user interface to access the extracted data;
verifying a user's password and sign-in credentials;
allowing logged-in users access to only data and functions intended for access by the user; and
performing searches on the data to which users have been given access.

16. The method of claim 13, further comprising:
manipulating data within the database component;
producing reports for the data;
adding new information to the data; and
maintaining an audit trail and log of the manipulated data.

17. A software framework system, comprising:
data from at least one legacy system; and
a database component that comprises disparate data sets; wherein a data extraction process is utilized to extract the data from the at least one legacy system, transform the extracted data into a text format and map the extracted data into the database component.

18. The software framework system of claim 17, further comprising a graphical user interface that users log into for access to data in the database component.

19. The software framework system of claim 18, further comprising an authorization component that establishes user access, permitted functions and permitted views of the data in the database component.

20. The software framework system of claim 19, further comprising a manipulation component that allows users to manipulate the data within the database component.
